(19) United States
(12) Patent Application Publication
(10) Pub. No.: US 2024/0271379 A1
(43) Pub. Date: Aug. 15, 2024

(54) Material Storage and Spreading System

(71) Applicant: Apply Right, LLC, Belgium, WI (US)

(72) Inventors: Nathan Benjamin Kohn, Eagle River, WI (US); Gregory Paul Stout, Stow, OH (US)

(21) Appl. No.: 18/437,537

(22) Filed: Feb. 9, 2024

Related U.S. Application Data
(63) Continuation of application No. PCT/US2024/014958, filed on Feb. 8, 2024.
(60) Provisional application No. 63/484,308, filed on Feb. 10, 2023.

(51) Int. Cl. E01H 10/00

(52) U.S. Cl. CPC E01H 10/007

(57) ABSTRACT

A granular material spreading system is provided. The granular material spreading system includes a spreading machine, a spreading frame, and a tote. The tote is configured to receive a granular, spreadable material and includes an opening allowing the granular material to exit the tote. The tote includes a spring-biased door blocking the opening. The door is opened by the spreading frame during spreading. When the spreading frame is coupled to the spreading machine, the tote is rotatable by the spreading machine between a storage position in which the opening in the tote is facing horizontally toward the spreading machine and a spreading position in which the opening in the tote is facing the ground surface.

### CROSS-REFERENCE TO RELATED PATENT APPLICATIONS

The present application is a continuation of International Application No. PCT/US2024/014958, filed on Feb. 8, 2024, which claims the benefit of and priority to U.S. Provisional Application No. 63/484,308 filed on Feb. 10, 2023, each of which is incorporated herein by reference in its entirety.

### BACKGROUND OF THE INVENTION

The present invention relates generally to a material storage and spreading system. The present invention relates specifically to a storage and spreading system for spreading granular materials (i.e., grit, rock salt, sand, etc.), such as de-icing materials (i.e., salt, ice melt, salt compounds, etc.).

In general, a distribution vehicle, such as a salt truck is used to spread granular materials and/or de-icing materials on various surfaces (roads, parking lots, walkways, etc.) because the de-icing material reduces the melting temperature of snow and/or ice while other granular materials may increase friction on the various surfaces for vehicles, pedestrians, etc. The granular materials are typically stored in centralized locations forcing the distribution vehicle to travel through snow and ice to retrieve the granular materials. The present invention relates to a spreading device or system intended to be located on-site (i.e., near road, parking lot, sidewalk) eliminating the time and costs associated with the distribution vehicle. Instead, the spreading device or system can be used with an on-site loading machine (i.e., skid loader, forklift, etc.).

### SUMMARY OF THE INVENTION

One embodiment of the invention relates to a granular material spreading system including a tote and a spreading frame. The tote includes a housing that includes walls, a cavity enclosed by the walls and an opening extending through one of the walls of the housing and connecting to the cavity. The tote further includes a door and a biasing component. The door is rotatably coupled to the housing such that the door in moveable between a closed position in which the door blocks the opening and an open position in which the opening is unblocked by the door. The biasing component is coupled to the door and biases the door toward the closed position. The spreading frame is configured to engage with and support the tote. The spreading frame includes a body, an upper support arm, and a lower support arm. The upper support arm is coupled to and extends outward from the body. The lower support arm is coupled to and extends outward from the body. The lower support arm is spaced a distance from the upper support arm such that a gap is defined between the upper support arm and the lower support arm. The spreading frame further includes a finger coupled to and extending outward from the body, the finger positioned between the upper support arm and the lower support arm. When the spreading frame is disengaged from the tote, the biasing component provides a closing force on the door such that the door is moved toward the closed position blocking the opening. When the spreading frame is engaged with the tote, the tote is positioned in the gap between the upper support arm and the lower support arm. The finger presses against the door of the tote, providing a force on the door such that the door is rotated away from the opening to the open position such that the opening is unblocked by the door.

In a specific embodiment, the spreading system further includes a spreading vehicle. The spreading frame is coupled to the spreading vehicle. When the spreading frame is coupled to the tote, the tote is rotatable by the spreading vehicle between a storage position in which the opening in the tote is facing horizontally toward the spreading vehicle and a spreading position in which the opening in the tote is facing the ground surface.

Another embodiment of the invention relates to a spreading frame. The spreading frame is configured to be engaged with a spreading vehicle and a tote carrying a granular, spreadable material. The spreading frame includes a body, an upper support arm, and a lower support arm. The body includes a forward-facing surface. The upper support arm is coupled to and extends outward from the body. The lower support arm is coupled to and extends outward from the body. The spreading frame further includes a finger and an auger. The finger is coupled to and extending outward from the forward-facing surface of the body. The finger is positioned between the upper support arm and the lower support. The auger is coupled to the body and extends outward from the body in a generally parallel orientation to the finger. The auger is positioned between the upper support arm and the lower support arm.

Another embodiment of the invention relates to storage tote for a granular, spreadable material. The storage tote includes a housing with walls including a side wall, a cavity enclosed by the walls and an opening extending through the side wall and connecting to the cavity. The storage tote further includes a door rotatably coupled to the housing and a biasing component having a first end coupled to the housing and a second end coupled to the door. The door is rotatable between a first position in which the door is positioned along the side wall of the housing such that the opening is covered and a second position in which the door is positioned away from the side wall of the housing such that opening is uncovered.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a granular material spreading system with a storage tote disengaged from a spreading frame and a spreading vehicle, according to an exemplary embodiment.

FIG. 2 is a side view of the granular material spreading system of FIG. 1, with the spreading frame and spreading vehicle engaged with the tote in a first, storage position, according to an exemplary embodiment.

FIG. 3 is a side view of the granular material spreading system of FIG. 2, with the tote in a second, spreading position, according to an exemplary embodiment.

FIG. 4 is a perspective view of the spreading frame of the granular material spreading system of FIG. 1 in the first, storage position, according to an exemplary embodiment.

FIG. 5 is a perspective view from above of the spreading frame of the granular material spreading system of FIG. 1, according to an exemplary embodiment.

FIG. 6 is a perspective view of the spreading frame engaged with the storage tote in the storage position, according to an exemplary embodiment.

FIG. 7 is a cross-sectional view of the spreading frame engaged with the storage tote in the storage position, according to an exemplary embodiment.

FIG. 8 is a detailed cross-sectional view of a door of the storage tote in a closed position, according to an exemplary embodiment.

FIG. 9 is a detailed cross-sectional view of the spreading frame engaged with the storage tote with the door in an open position, according to an exemplary embodiment.

FIG. 10 is a perspective view of the spreading frame engaged with the storage tote in the spreading position, according to an exemplary embodiment.

FIG. 11 is a cross-sectional view of the spreading frame engaged with the storage tote in the spreading position, according to an exemplary embodiment.

FIG. 12 is a detailed cross-sectional view of FIG. 11 with the door in an open position, according to an exemplary embodiment.

FIG. 13 is a front perspective view of the tote of the granular material spreading system of FIG. 1, according to an exemplary embodiment.

FIG. 14 is a front perspective view of the tote of FIG. 13, with a first portion of a lid open, according to an exemplary embodiment.

FIG. 15 is a front perspective view of the tote of FIG. 14, filled with a granular spreading material and with the first and second portions of the lid open, according to an exemplary embodiment.

### DETAILED DESCRIPTION

Referring generally to the figures, various embodiments of a storage and spreading device and/or system, shown as a granular material spreading system, are shown. Various embodiments of the storage spreading device and/or system discussed herein include are configured to be located on site (i.e., near road, parking lot, sidewalk) to eliminate the time, costs, and safety hazards associated with using a distribution vehicle (i.e., salt truck). As will be generally understood, distributions vehicles typically retrieve granular materials (i.e., grit, rock salt, sand, etc.), such as de-icing materials (i.e., grit, rock salt, sand, etc.) from a centralized location during a weather event (i.e., snow, ice storm, etc.) before traveling out to deliver the granular materials.

In various embodiments, the granular material spreading system includes a loading machine, a spreading frame, and a storage container. The storage container is designed to provide improved protection to the granular materials stored within the storage container by use of an exit opening door. In contrast to the storage container discussed herein, storage containers may have insufficient protection (i.e., susceptible to leaks, allow entry of moisture, etc.) for granular materials stored on site due to use of selectively permeable closures or barriers at the exit opening of the container.

Applicant believes use of a door that acts as a solid barrier to the exit opening or outlet of the container when the container is being used for storage reduces the likelihood of damage (water damage, freezing and/or clumping together, etc.) to the granular materials. Various embodiments discussed herein related to a storage container with a moveable door located at the exit opening of the container. When the container is being used for storage, the door is positioned to block the exit opening of the container. When a user is ready to use the container for spreading the granular material, engagement between the spreading frame and container moves the door to a position away from the exit opening, so the opening is unblocked by the door.

Further, Applicant believes use of moveable door rather than a selectively permeable closure allows for improved ease and/or efficiency of spreading the granular materials. While a selectively permeable closure may require the granular materials to exert a force and/or deform the closure during spreading of the material, the spreading system discussed herein has an unblocked exit opening during spreading of the material such that the material can be spread with reduced resistance. Additionally, the design of the spreading frame discussed herein provides for efficient and automatic opening of the door during engagement between the spreading frame and the container at the time the user intends to use the system to spread the material.

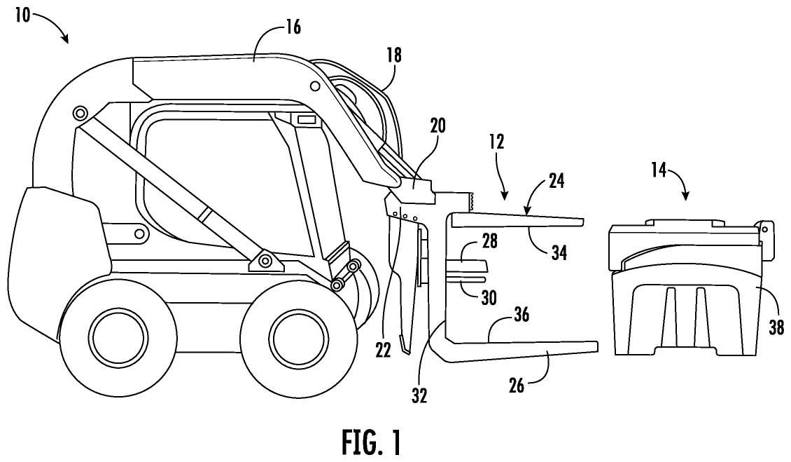

Referring to FIGS. 1-3, various aspects of a storage and spreading device and/or system, shown as a granular material spreading system 10 are shown. In general, granular material spreading system includes a spreading machine 16, a frame shown as a spreading frame 12, and a container, shown as a tote 14. Spreading machine or vehicle 16 is a loading machine (i.e., skid loader, forklift, tractor, etc.). Spreading machine 16 includes a loading arm or boom to move the spreading frame 12 and/or tote 14. In a specific embodiment, spreading machine 16 is powered by a hydraulic system and includes hydraulic lines 18. Hydraulic lines 18 can be connected to spreading frame 12 and/or tote 14 to power components of spreading frame 12 and/or tote 14.

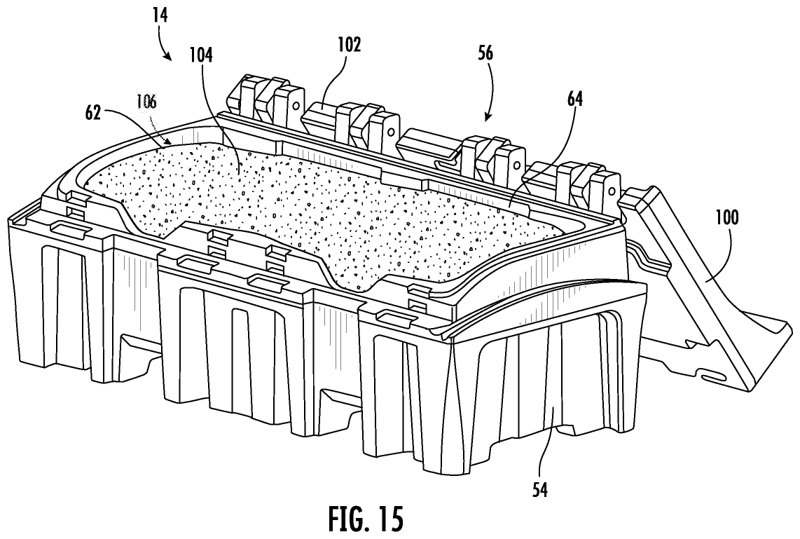

Tote 14 is configured to store granular materials 104 (i.e., grit, rock salt, sand, etc., see e.g., 104 in FIG. 15), such as de-icing materials (i.e., salt, ice melt, salt compounds, etc.) at on-site locations near or at desired spreading areas (i.e., roads, parking lots, sidewalks, etc.). Specifically, a housing 38 of tote 14 stores the granular materials 104. As will be discussed in greater detail below, housing 38 includes a plurality of walls such as top wall 40, bottom wall 42, front wall 50, rear wall 48 and side walls 94. In various specific embodiments, the granular material 104 is an ice melt or ice melting material. In such an embodiment, the ice melt material reduces the melting temperature of snow and/or ice to facilitate the melting of snow or ice on spreading areas.

Spreading frame 12 is coupled to spreading machine 16 by a vehicle coupling interface 20 that connects the spreading frame 12 to spreading vehicle 16. Spreading frame 12 is configured to engage with and support the tote 14 during the process of spreading the granular material at the desired spreading areas. Spreading frame 12 includes a body 22 with an upper support arm 24 and a lower support arm 26. In various specific embodiments, spreading frame 12 includes a pair of upper support arms 24 and a pair of lower support arms 26. Upper support arm 24 is coupled to and extends outward from body 22. Similarly, lower support arm 26 is coupled to and extends outward from body 22 of spreading frame 12.

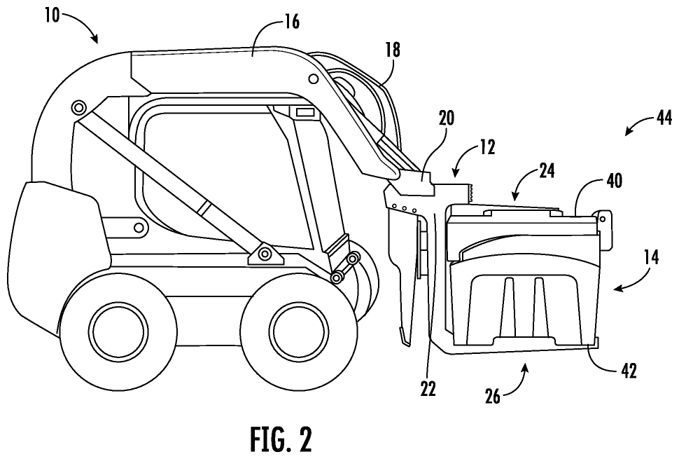

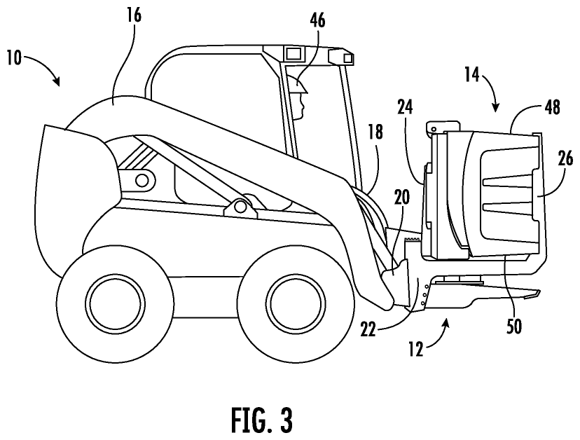

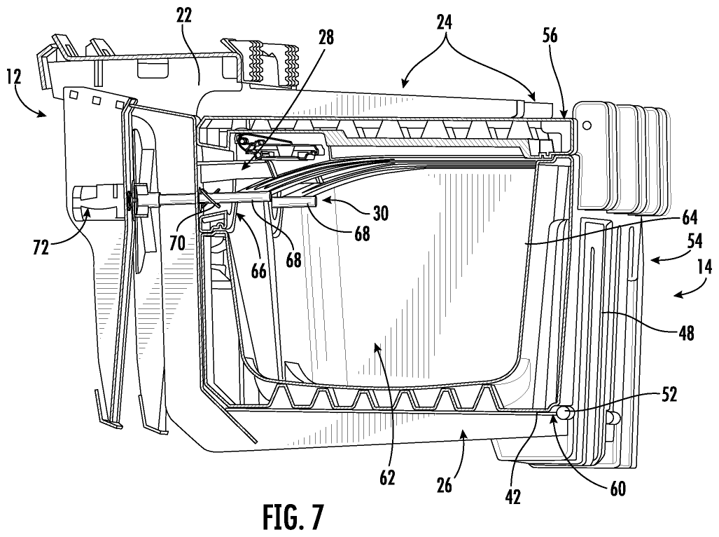

As shown in FIG. 1, when the spreading machine 16 is coupled to the spreading frame 12, the spreading machine 16 may be driven to the location where the tote 14 is storing the granular material. Spreading machine 16 and spreading frame 12 can then pick up and/or engage tote 14 that is in a first, storage position. When tote 14 is in the storage position, top wall 40 in an upward facing orientation with bottom wall 42 in a downward facing orientation (see e.g., FIG. 2). When an operator 46 of spreading machine 16 has reached a chosen spreading area and wishes to begin spreading the granular material stored within tote 14, the operator 46 can rotate tote 14 in a direction shown by arrow 44, moving tote 14 into a second, spreading position, shown in FIG. 3. In other words, when spreading frame 12 is coupled to spreading machine 16 and when spreading frame 12 is coupled to tote 14, tote 14 is rotatable by the spreading machine 16 between a storage position in which an opening 66 (See FIG. 7) in the tote is facing in a direction horizontally toward the spreading machine 16 and a spreading position in which the opening 66 in the tote is facing the ground surface.

In a specific embodiment, direction 44 is counterclockwise. In other embodiments, tote 14 may be rotated in a counterclockwise direction to move into the spreading position (i.e., if the opening were positioned on what is considered rear wall 48). When tote 14 is in the spreading position, top wall 40 is oriented in a direction facing spreading machine 16 while front wall 50 is facing the ground surface (see e.g., FIG. 3).

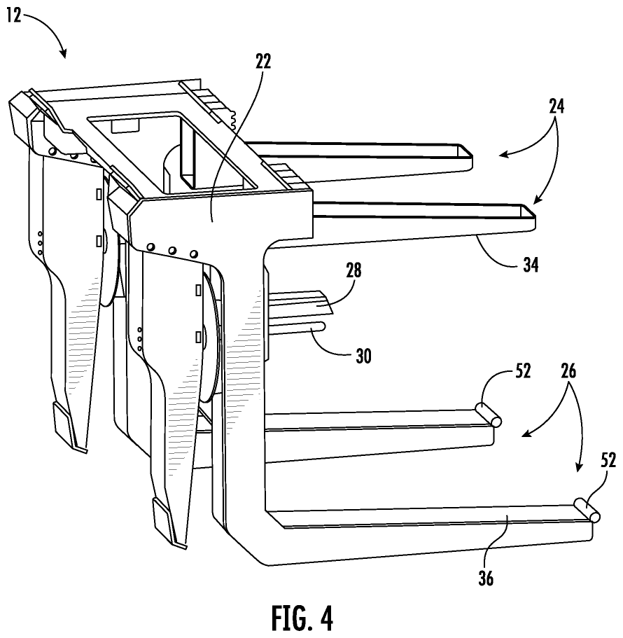

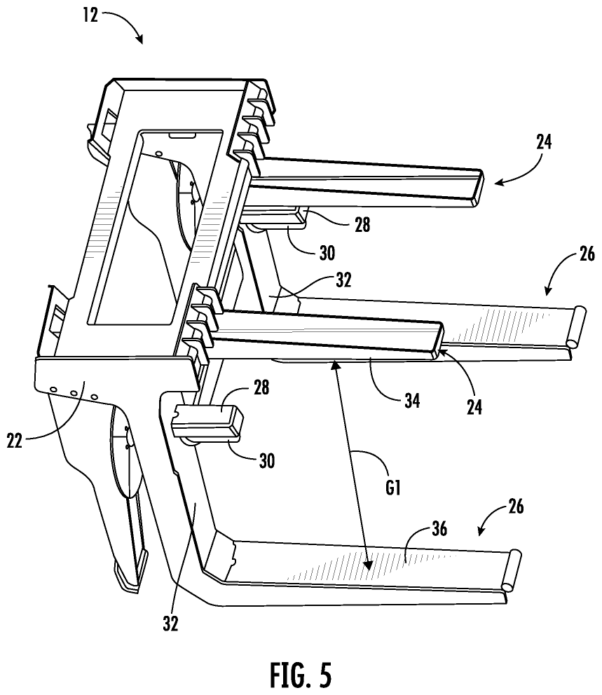

Referring to FIGS. 4-5, details of spreading frame 12 are shown according to an exemplary embodiment. Body 22 includes a forward-facing surface 32 that faces front wall 50 of tote 14 when spreading frame 12 engages with tote 14. Upper support arm 24 includes a lower surface, shown as downward facing surface 34 (in the orientation shown in FIG. 4). Lower support arm 26 includes an upper surface, shown as upward facing surface 36 (in the orientation shown in FIG. 4). Lower support arm 26 is spaced a distance from upper support arm 24 such that a gap or space exists between lower support arm 26 and upper support arm 24. The gap, G1 is sized to receive the housing 38 of tote 14. G1 is defined between the upper support arm 24 and lower support arm 26. More specifically, G1 is defined between lower surface 34 of upper support arm 24 and upper surface 36 of lower support arm 26.

Spreading frame 12 further includes a projection, shown as finger 28 that is coupled to and extends outward from body 22. Finger 28 is positioned between upper support arm 24 and lower support arm 26. As will be described in greater detail below, when spreading frame 12 is engaged with tote 14, tote 14 is positioned between upper support arm 24 and lower support arm 26 and finger 28 presses against tote 14 to unblock the exit opening 66 of tote 14. Spreading frame 12 further includes an agitator, shown as auger 30. Auger 30 is coupled to body 22 and extends outward from body 22 in a generally parallel (i.e., longitudinal axis of finger 28 is parallel to longitudinal axis of auger 30, same orientation plus or minus 10 degrees) orientation to finger 28. In various specific embodiments, auger 30 extends outward from body 22 in an auger orientation that is plus or minus 30 degrees from a finger orientation of finger 28. In various specific embodiments, spreading frame 12 includes a pair of fingers 28 and a pair of augers 30 each extending away from one of the surfaces 32 between upper support arm 24 and lower support arm 26.

In various specific embodiments, a distal end of lower support 26 includes a projection 52. Projection 52 engages a portion of bottom wall 42 and acts as stopper (i.e., helps retain tote 14 on lower support arm 26) when tote 14 is engaged with spreading frame 12. Specifically, projection 52 engages with a recessed portion 60 (see e.g., FIG. 7) of bottom wall 42 to resist movement of tote 14 from a position on and/or engaged with lower support arm 26.

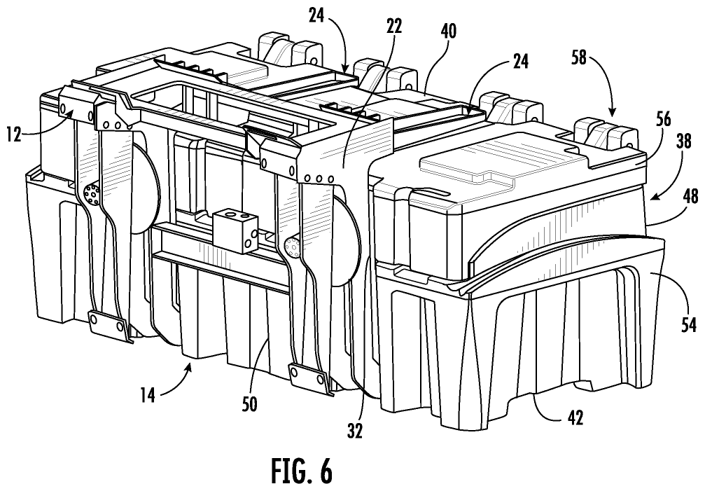

Referring to FIGS. 6-7, views of tote 14 engaged with spreading frame 12 while tote 14 is in the storage position are shown. As previously discussed, housing 38 of tote 14 includes a plurality of walls. In various specific embodiments, housing 38 includes a base or lower portion 54 and a lid or upper portion 56. In a specific embodiment, lid 56 is a pivoting lid coupled to and extending between front wall 50 and rear wall 48. In such an embodiment, lid 56 may be coupled to base 54 by a hinge 58. In various specific embodiments, lid 56 is coupled to base 54 by a plurality of hinges 58.

When tote 14 is engaged with spreading frame 12, upper support arm 24 and lower support arm 26 are positioned on opposing sides of housing 38. Specifically, lower support arm 26 extends along and supports bottom wall 42 and upper support arm 24 extends along and/or engages top wall 40 (in the orientation shown in FIGS. 6-7).

As shown in FIG. 7, the engagement between spreading frame 12 and tote 14 includes engagement with the opening, shown as exit opening 66 of tote 14. In various specific embodiments, exit opening 66 extends through front wall 50 of housing 38 and connects to a cavity 62 enclosed by the walls of housing 38. In various specific embodiments, tote 14 includes a pair of openings 66. Cavity 62 is defined by an interior surface 64 of tote 14 and configured to receive the granular material 104. In other specific embodiments, the exit opening 66 can be placed on another wall of the housing (i.e., rear wall 48, top wall 40, bottom wall 42, etc.).

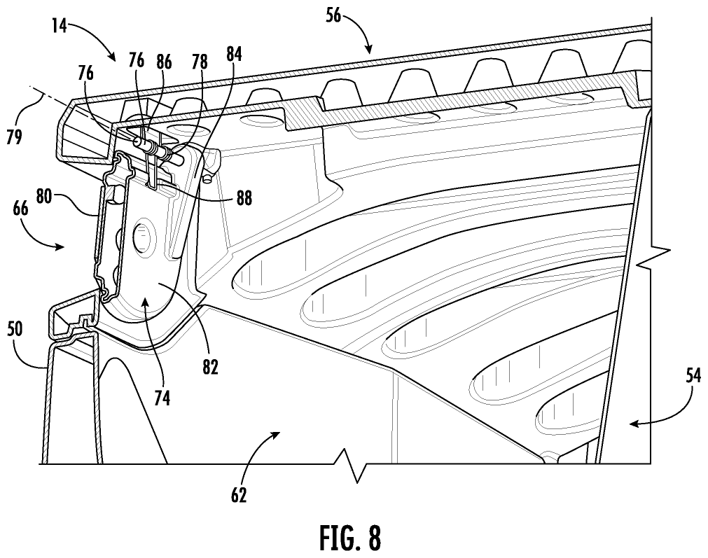

Tote 14 further includes a cover or door 74 that is rotatably coupled to housing 38. In a specific embodiment, door 74 is rotatably coupled to housing 38 by a pin 76. The door 74 is moveable between a closed position (see e.g., FIG. 8) in which door 74 blocks or covers opening 66 and an open position in which opening 66 is unblocked by door 74. Tote 14 includes a biasing component, shown as a spring 78. Spring 78 is coupled to door 74 and biases the door 74 toward the closed position.

Referring to FIG. 8, a detailed cross-sectional view of tote 14 with door 74 in a closed position is shown, according to an exemplary embodiment. When tote 14 is disengaged from (i.e., not touching and/or attached to) spreading frame 12, spring 78 provides a closing force on door 74 such the door 74 is moved toward the closed position blocking opening 66. Spring 78 has a first end 86 and a second end 88 that opposes the first end 86. First end 86 of spring 78 is coupled to housing 38 and second end 88 is coupled to door 74. In a specific embodiment, spring 78 is a torsion spring. In other words, in such an embodiment, the biasing component 78 is a torsion spring.

Door 74 further includes a protrusion or door arm 84 coupled to an inward facing (in the orientation shown in FIG. 8) surface 82. In a specific embodiment, pin 76 extends along a longitudinal pin axis 79 and connects a pair of opposing door arms 84. The axis of rotation of spring 78 is parallel to the longitudinal pin axis 79. In a specific embodiment, the axis of rotation of spring 78 is colinear with longitudinal pin axis 79. Door 74 includes an outward facing surface 80. When door 74 is in the closed position, inward facing surface 82 and outward facing surface 80 extend in a generally parallel orientation to interior surface 64 of housing and/or front wall 50.

As door 74 moves into the open position, inward facing surface 82 rotates toward a position in which inward facing surface faces top wall 40 of housing 38. At the same time outward facing surface 80 moves into a position where outward facing surface 80 has a generally perpendicular orientation (i.e., 90 degrees plus or minus 10 degrees) to front wall 50 and faces bottom wall 42. When door 74 is in the open position, the housing 38 is open such that a material positioned within the cavity 62 is removable from housing 38.

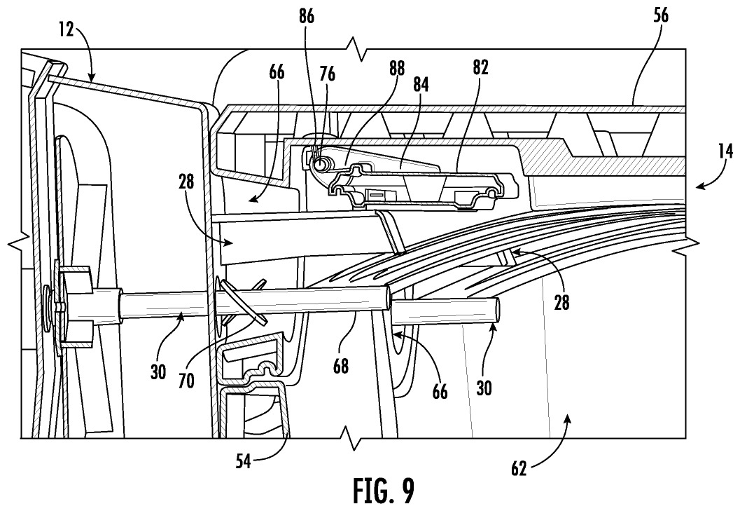

When spreading frame 12 is engaged with tote 14, finger 28 presses against and/or engages door 74, providing an opening force on door 74 such that the door is rotated away from opening 66 to the open position (see e.g., FIGS. 7, 9) such that opening 66 is unblocked by door 74. When door 74 is in the open position, a material positioned within housing 38 and/or cavity 62 is removable from the housing 38. As finger 28 engages door 74, the second end 88 of spring 78 deflects such that spring 78 stores energy. When finger 28 disengages from door 74, spring 78 releases energy driving rotation of door 74 to a position covering opening 66 in the tote (i.e., closed position).

As frame 12 is engaging with tote 14, finger 28 extends through the opening 66 into cavity 62 of housing 38. Similarly, auger 30 and specifically a distal end of auger 30 extends through opening 66 into cavity 62. Auger 30 further includes a rotatable shaft 68 and a blade 70. In a specific embodiment, shaft 68 of auger 30 has a generally cylindrical shape. Blade 70 is coupled to and extends at least partially around shaft 68 of auger 30. A proximal end 72 of auger 30 that remains outside of tote 14 even during engagement between spreading frame 12 and tote 14, is configured to be connected to a power source. In other words, a motor of auger 30 can be connected to a power source to drive auger 30.

In a specific embodiment, auger 30 is connected to the hydraulic system of the spreading machine 16 by the hydraulic lines 18. When auger 30 is turned on and/or activated, the shaft 68 rotates about a longitudinal axis of the auger 30. As the shaft 68 of the auger 30 rotates, blade 70 rotates. When cavity 62 is filled with the granular material and door 74 is open, the auger 30 and auger blade 70 create a force that moves and/or pulls the granular material toward or through opening 66.

Referring to FIG. 9, a detailed cross-sectional view of tote 14 with door 74 in an open position is shown, according to an exemplary embodiment. When tote 14 is engaged with (i.e., touching and/or attached to) spreading frame 12, finger 28 provides the opening force on door 74 by pressing and/or interfacing against outward facing surface 80 of door 74. Such engagement moves the door 74 is moved toward the open position shown, where opening 66 is unblocked and/or uncovered. Finger 28 extends through opening 66 in a position that allows finger 28 to hold door 74 in the open position.

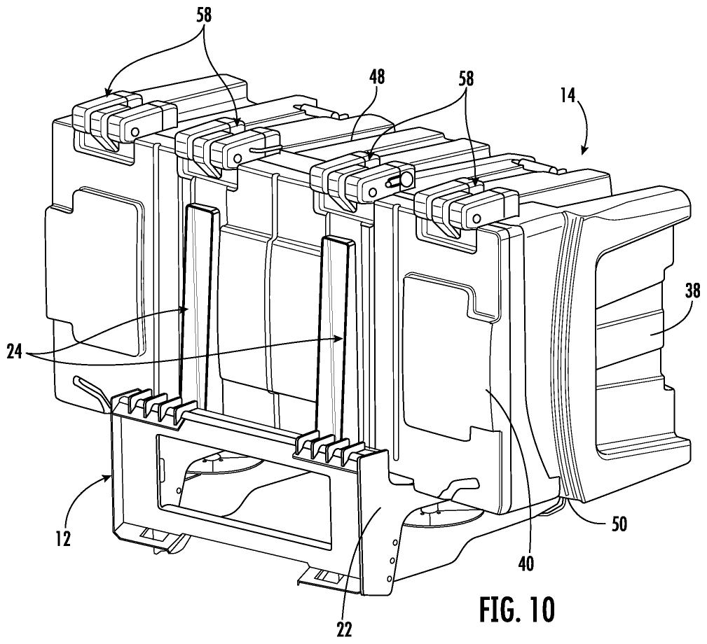

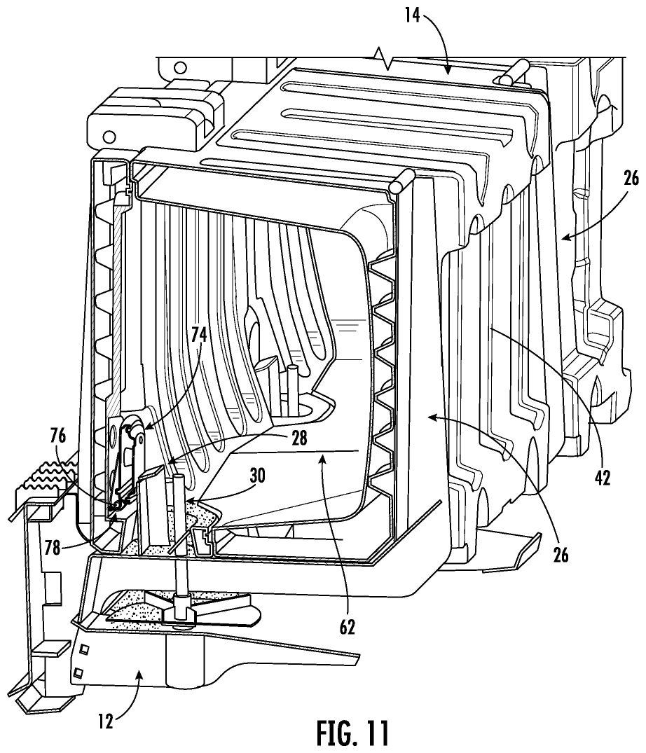

Referring to FIGS. 10-12, views of tote 14 engaged with spreading frame 12 while tote 14 is in the rotated, spreading position are shown. As previously noted, when tote 14 is in the spreading position, top wall 40 is oriented in a direction facing spreading machine 16 while front wall 50 is facing the ground surface. Because door 74 is engaged with spreading frame 12 and in the open position, the granular material 104 stored in cavity can exit through opening 66 to be deposited on the ground surface. In other words, when spreading frame 12 is engaged with tote 14 and tote 14 is rotated into the spreading position, the granular material 104 stored within cavity 62 of tote 14 exits through opening 66 and is spreadable onto the ground surface (see e.g., FIG. 11).

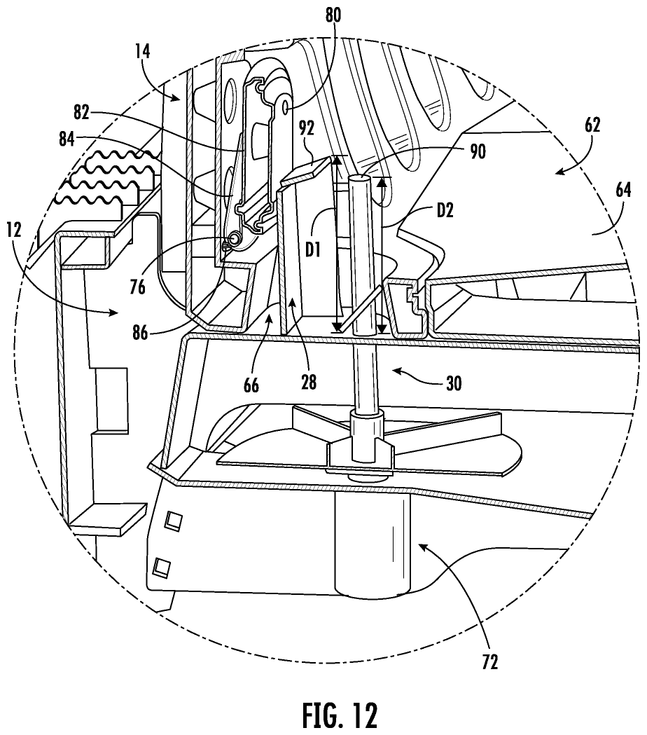

Referring to FIG. 12, a detailed cross-sectional view of tote 14 with door 74 in an open position and the tote shown in the spreading position is shown, according to an exemplary embodiment. Finger 28 further includes a forward-facing engagement surface, shown as angled surface 92. Angled surface 92 presses against the outward facing surface 80 of door 74 when engagement between tote 14 and spreading frame 12 begins. In other words, angled surface 92 is configured to engage and move door 74 of tote 14. Finger 28 extends outward from forward-facing surface 32 of spreading frame 12 a first distance, D1. D1 is defined as the distance between forward-facing surface 32 and angled surface 92 of finger 28. Auger 30 and specifically shaft 68 includes an end surface 90. Auger 30 extends beyond forward-facing surface 32 by a second distance D2. D2 is defined as the distance between forward-facing surface 32 and end surface 90.

In various specific embodiments, finger 28 extends a first distance, D1 from the forward-facing surface 32 of body 22 and auger 30 extends a second distance, D2 from forward-facing surface 32 of body 22. In a specific embodiment, the first distance is different than the second distance. In a specific embodiment, the first distance is greater than the second distance. The greater extension of finger 28 allows for the opening of door 74 without creating an engagement force on auger 30 that may damage shaft 68 (i.e., closing force from spring 78).

Further, the auger spacing or distance between finger 28 and auger 30 should be a small distance. The auger spacing is small enough that finger 28 opens door 74 for auger 30 and also large enough that finger 28 engages or interferes with auger 30 and specifically shaft 68 or blade 70. In various specific embodiments, the auger spacing is about 1 inch (i.e., 1 inch plus or minus 1 inch). In a specific embodiment, the auger spacing is about 1 inch or less (i.e., 1 inch plus or minus 0.1 inches).

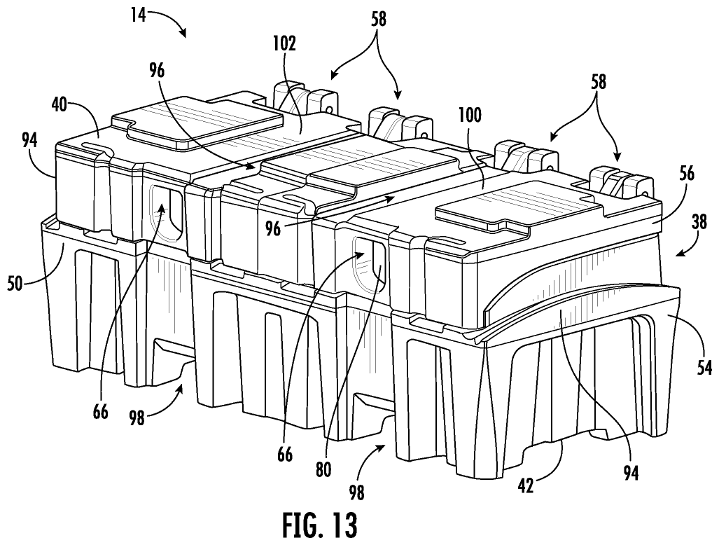

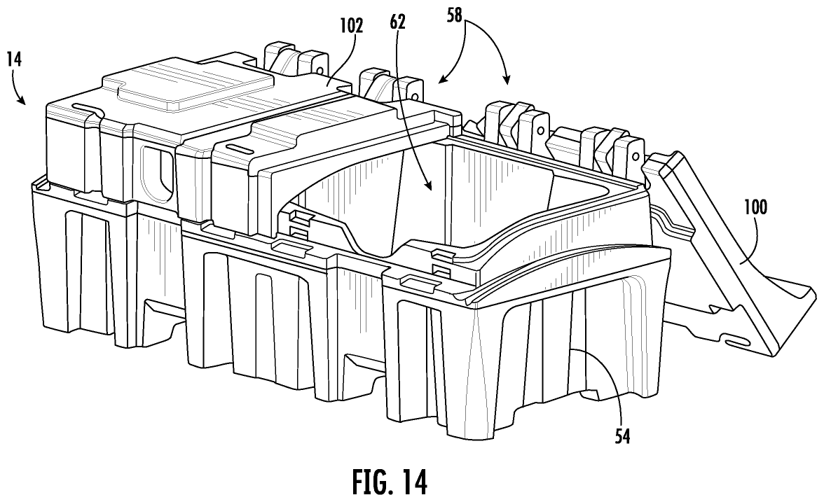

Referring to FIGS. 13-15, perspective views of tote 14 are shown, according to an exemplary embodiment. In a specific embodiment, lid 56 includes a first side 100 and a second side 102. The first side 100 and second side 102 of lid 56 can be opened independently of each other. As shown in FIG. 14, first side 100 of lid 56 can be opened while second side 102 remains in a closed, covering position.

When both the first side 100 and second side 102 of lid are opened (see e.g., FIG. 15), the filling opening 106 of housing 38 is open. The first side 100 and second side 102 of lid 56 each extend between front wall 50 and rear wall 50 to cover the filling opening 106 when the granular material 104 has been placed in and/or cavity 62 is filled.

In a specific embodiment, housing 38 and specifically top wall 40 and bottom wall 42 include structures configured to engage with spreading frame 12. Top wall 40 includes a recessed portion 96 receives and/or engages with upper support arm 24 when tote 14 is engaged with spreading frame 12. Similarly, bottom wall 42 includes a recessed portion 98 that receives and/or engages with lower support arm 26 when tote 14 is engaged with spreading frame 12.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A granular material spreading system comprising:
a tote comprising:
a housing comprising:
walls;
a cavity enclosed by the walls; and
an opening extending through one of the walls of the housing and connecting to the cavity;
a door rotatably coupled to the housing such that the door is moveable between a closed position in which the door blocks the opening and an open position in which the opening is unblocked by the door; and
a biasing component coupled to the door biasing the door toward the closed position; and
a spreading frame configured to engage with and support the tote, the spreading frame comprising:
a body;
an upper support arm coupled to and extending outward from the body;
a lower support arm coupled to and extending outward from the body, the lower support arm is spaced a distance from the upper support arm such that a gap is defined between the upper support arm and the lower support arm; and
a finger coupled to and extending outward from the body, the finger positioned between the upper support arm and the lower support arm;
wherein, when the spreading frame is disengaged from the tote, the biasing component provides a closing force on the door such that the door is moved toward the closed position blocking the opening; and
wherein, when the spreading frame is engaged with the tote, the tote is positioned in the gap between the upper support arm and the lower support arm, and the finger presses against the door of the tote, providing a force on the door such that the door is rotated away from the opening to the open position such that the opening is unblocked by the door.

2. The spreading system of claim 1, further comprising a spreading vehicle and the spreading frame is coupled to the spreading vehicle, wherein, when the spreading frame is coupled to the tote, the tote is rotatable by the spreading vehicle between a storage position in which the opening in the tote is facing in a direction horizontally toward the spreading vehicle and a spreading position in which the opening in the tote is facing the ground surface.

3. The spreading system of claim 2, further comprising a granular material located in the cavity of the tote, wherein, when spreading frame is engaged with the tote and the tote is rotated into the spreading position, the granular material stored within the cavity of the tote exits through the opening and is spreadable onto the ground surface.

4. The spreading system of claim 3, wherein the granular material is an ice melting material.

5. The spreading system of claim 1, the spreading frame further comprising an auger with a rotatable shaft coupled to the body and extending outward from the body in a generally parallel orientation to the finger.

6. The spreading system of claim 1, wherein the biasing component has a first end coupled to the housing and a second end coupled to the door.

7. The spreading system of claim 6, wherein, when the finger engages the door, the second end of the biasing component deflects such that the biasing component stores energy; and
wherein, when, the finger disengages from the door, the biasing component releases energy driving rotation of the door to a position covering the opening in the tote.

8. The spreading system of claim 1, wherein the door is rotatably coupled to the housing by a pin.

9. A spreading frame configured to be engaged with a spreading vehicle and a tote carrying a granular, spreadable material comprising:
a body including a forward-facing surface;
an upper support arm coupled to and extending outward from the body;
a lower support arm coupled to and extending outward from the body;
a finger coupled to and extending outward from the forward-facing surface of the body, the finger positioned between the upper support arm and the lower support arm; and
an auger coupled to the body and extending outward from the body in a generally parallel orientation to the finger, the auger positioned between the upper support arm and the lower support arm.

10. The spreading frame of claim 9, wherein the spreading frame is coupled to a vehicle coupling interface that connects the spreading frame to the spreading vehicle.

11. The spreading frame of claim 9, wherein the finger extends a first distance from the forward-facing surface of the body and wherein the auger extends a second distance from the forward-facing surface of the body.

12. The spreading frame of claim 11, wherein the first distance is greater than the second distance.

13. The spreading frame of claim 8, wherein the finger includes a forward-facing angled surface configured to engage and move a door on a storage tote.

14. A storage tote for a granular, spreadable material comprising:
a housing comprising:
walls including a side wall;
a cavity enclosed by the walls; and
an opening extending through the side wall and connecting to the cavity;
a door rotatably coupled to the housing; and
a biasing component having a first end coupled to the housing and a second end coupled to the door;
wherein the door is rotatable between a first position in which the door is positioned along the side wall of the housing such that the opening is covered, and a second position in which the door is positioned away from the side wall of the housing such that the opening is uncovered.

15. The storage tote of claim 14, wherein, when the door is in the first position, the biasing component provides a force on the door such that the door blocks the opening and further comprising the granular, spreadable material positioned within the cavity.

16. The storage tote of claim 15, wherein the granular, spreadable material is an ice melt material.

17. The storage tote of claim 14, wherein, when the door is in the second position, the housing is open such that a material positioned within the cavity is removable from the housing.

18. The storage tote of claim 14, wherein the side wall with the opening is a front wall and the walls further include a rear wall.

19. The storage tote of claim 18, further comprising pivoting lids coupled to and extending between the front wall and the rear wall covering a filling opening.

20. The storage tote of claim 14, wherein the biasing component is a torsion spring.
